(19) United States
(12) Patent Application Publication
(10) Pub. No.: US 2008/0068837 A1
(43) Pub. Date: Mar. 20, 2008

(54) LED LAMP

(75) Inventors: Shan-Ching Chiu, Sindian City (TW); Yen-Lan Chiu, Sindian City (TW)

Correspondence Address: IDEALITE OPTOELECTRONICS, INC., P.O. BOX 108-00403, TAIPEI 106, omitted

(73) Assignee: IDEALITE OPTOELECTRONICS INC., Sindian City, Taipei Hsien (TW)

(21) Appl. No.: 11/532,106

(22) Filed: Sep. 15, 2006

(51) Int. Cl. F21V 5/00

(52) U.S. Cl. 362/244; 362/240

(57) ABSTRACT

A LED lamp is disclosed to include two LEDs arranged opposite to each other on a bracket and electrically connected to an electric connector connectable to an external power source, and a lens shell covering the LEDs. The lens shell has vertical prism ribs spaced around the inside wall and horizontal prism teeth extending around the outside wall at different elevations and respectively sloping in one direction at a respective angle to enhance the light field during operation of the LEDs.

### BACKGROUND OF THE INVENTION

1. Field of the Invention

The present invention relates to lamps and more particularly, to a high durability and low power consumption type LED lamp, which has two LES arranged opposite to each other to provide a strong light field.

2. Description of the Related Art

LED (light emitting diode) is a semiconductor product that lights up when electricity is passed through it. LEDs are good for displaying images because they can be relatively small, and they do not burn out. Further, for the advantages of low driving voltage, low power consumption, high durability, quick reaction speed, and high shock strength, LEDs are intensively used in consumer electronics, communication products, information industry, vehicles, industrial instruments, etc. Following improvement of manufacturing yield rate and reduction of unit manufacturing cost, the demand for LEDs keeps increasing. Nowadays, LEDs have been intensively used in lighting fixtures to substitute for conventional incandescent and fluorescent lamps.

Further, a conventional rotary signal lamp is comprised of an incandescent bulb and a rotating concave lens. The rotating concave lens is turned about the incandescent bulb when the incandescent bulb is turned on, thereby producing a flashing warning signal. This design of rotary signal lamp has drawbacks. The fabrication of the rotary concave lens is complicated. Further, the incandescent bulb consumes much power and burns out quickly with use.

Further, a conventional xenon lamp produces light by electrical discharge in xenon under high pressure. A xenon lamp provides a high strength light field. However, it becomes unstable after a certain period of time in working. Further, the xenon tube and the related electronic circuit are complicated, resulting in a high manufacturing cost.

Further, there are LED lamps that have a big number of LEDs (more than ten or several tens of LEDs) coupled into a cylindrical structure to provide a 360° light source. A LED lamp of this design is complicated and inexpensive to manufacture.

Therefore, it is desirable to provide a LED lamp that eliminates the drawbacks of the aforesaid various conventional lamp designs.

### SUMMARY OF THE INVENTION

The present invention has been accomplished under the circumstances in view. It is therefore the main object of the present invention to provide a LED lamp, which provides an enhanced light field and saves much power consumption. It is another object of the present invention to provide a LED lamp, which is easy and inexpensive to manufacture and, durable in use.

To achieve these and other objects of the present invention, the LED lamp comprises two LEDs (light emitting diodes) and a lens shell houses the two LEDs. The two LEDs are arranged opposite to each other and kept apart at a predetermined distance, each having a light emitting body that emits light at a predetermined forward wide angle. The light emitting bodies of the two LEDs are aimed at each other such that the forward wide angle of the projection of light from one LED is overlapped with the forward wide angle of the projection of light from the other LED, thereby enhancing the light field. Further, the lens shell has vertical prism ribs spaced around the inside wall and horizontal prism teeth extending around the outside wall at different elevations and respectively sloping in one direction at a respective angle to enhance the light field during operation of the LEDs.

### BRIEF DESCRIPTION OF THE DRAWINGS

FIG. 1 is a schematic sectional view of a LED lamp according to the present invention.

FIG. 2 is an elevational view of the LED lamp according to the present invention.

### DETAILED DESCRIPTION OF THE PREFERRED EMBODIMENT

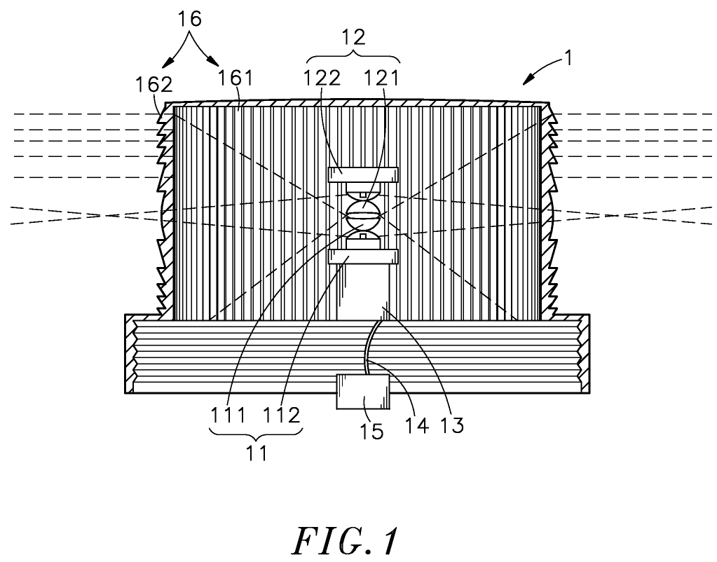

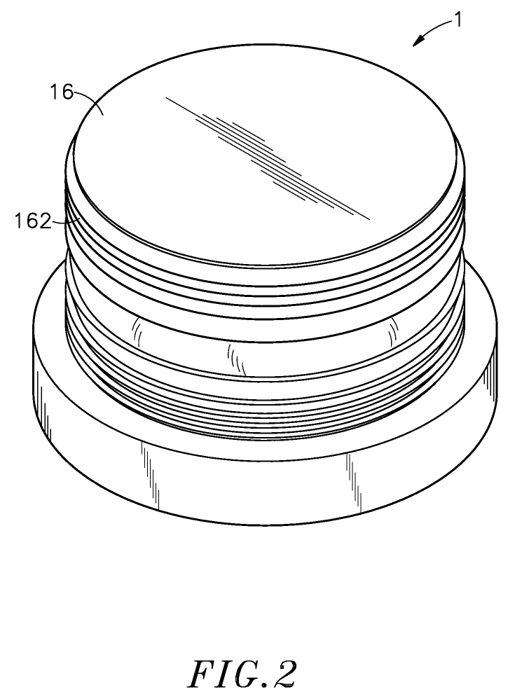

Referring to FIGS. 1 and 2, a LED lamp 1 in accordance with the present invention is shown comprised of a first LED (light emitting diodes) 11, a second LED 12, a bracket 13, a connector 15, and a lens shell 16.

The first LED 11 and the second LED 12 each have a LED body 111 or 121 that emits light at a forward wide angle (about 170°), and a heat sink 112 or 122 that dissipates heat when the LED body 111 or 121 is turned on to emit light. Further, the first LED 11 and the second LED 12 are bonded to the bracket 13 in an opposite manner such that the LED bodies 111 and 121 are aimed at each other and kept close to each other. The first LED 11 and the second LED 12 are electrically connected to the electric connector 15 by electric wires 14. The electric connector 15 is electrically connected to an external circuit board (not shown) that provides power supply to the first LED 11 and the second LED 12 and controls on/off, light intensity and flashing status of the first LED 11 and the second LED 12. The lens shell 16 is made of a transparent material and covers the LEDs 11 and 12 and the bracket 13, having a plurality of vertical prism ribs 161 spaced around the inside wall and a plurality of horizontal prism teeth 162 extending around the outside wall at different elevations and respectively sloping in one direction at a respective angle. The lens shell 16 shown in FIGS. 1 and 2 is simply an example of the present invention. It may be variously shaped, or made to show any of a variety of designs.

As stated above, the first LED 11 and the second LED 12 are set opposite to each other with the respective LED bodies 111 and 121 aimed at each other and kept close to each other. Thus, the forward wide angle (about 170°) of the projection of light from the first LED 1 and the forward wide angle (about 170°) of the projection of light from the second LED 2 are overlapped, providing a strong and wide-area light field (The light field, also known as the plenoptic function or radiance field, is a function that describes the amount of light travelling through every point in 3D space in every possible direction), eliminating illumination dead angle. When the first LED 1 and the second LED 2 are turned on to emit light, the vertical prism ribs 161 refract light from the LEDs 1 and 2 vertically through 360°, and the horizontal prism teeth 162 refract light in horizontal. Thus, the light intensity is enhanced, i.e., the LED lamp 1 provides a high intensity light field.

As described above, the LED lamp 1 of the present invention has the following benefits:

1. Because the invention simply uses two LEDs 11 and 12 to provide light and the two LEDs 11 and 12 are set opposite to each other, the LED lamp 1 of the present invention is durable in use and saves much power consumption when compared to conventional incandescent or fluorescent lamps.

2. Because the two LEDs 11 and 12 are set opposite to each other, the forward wide angle (about 170°) of the projection of light from the LED body 111 of the first LED 1 and the forward wide angle (about 170°) of the projection of light from the LED body 121 of the second LED 2 are overlapped, providing a strong and wide-area light field. When compared with the conventional xenon lamp that produces light by electrical discharge in xenon under high pressure, the LED lamp 1 of the present invention is easy and inexpensive to manufacture.

A prototype of LED lamp has been constructed with the features of FIGS. 1 and 2. The LED lamp functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An LED lamp comprising:
two light emitting diodes arranged opposite to each other and kept apart at a predetermined distance, said two light emitting diodes each having a light emitting body that emits light at a predetermined forward wide angle, the light emitting bodies of said two light emitting diodes being aimed at each other such that the forward wide angle of the projection of light from one of said two light emitting diodes being overlapped with the forward wide angle of the projection of light from the other light emitting diode;
an electric connector electrically connected to said two light emitting diodes for connecting said two light emitting diodes to an external power source; and
a lens shell covering said two light emitting diodes.

2. The LED lamp as claimed in claim 1, further comprising a bracket holding said two light emitting diodes in position.

3. The LED lamp as claimed in claim 1, wherein said two light emitting diodes each have a heat sink for dissipation of heat during operation of the respective light emitting body.

4. The LED lamp as claimed in claim 1, wherein said lens shell is a transparent member having a plurality of vertical prism ribs spaced around an inside wall thereof and a plurality of horizontal prism teeth extending around an outside wall thereof at different elevations and respectively sloping in one direction at a respective angle.
